(19) United States
(12) Patent Application Publication
(10) Pub. No.: US 2012/0190802 A1
(43) Pub. Date: Jul. 26, 2012

(54) POLYIMIDE POLYMER FROM NON-STOICHIOMETRIC COMPONENTS

(75) Inventors: Garrett D. Poe, Madison, AL (US); Robert Henry, Huntsville, AL (US); Lonnie F. Bradburn, JR., Athens, AL (US); Brandon S. Farmer, Knoxville, TN (US)

(73) Assignee: Nexolve Corporation, Huntsville, AL (US)

(21) Appl. No.: 13/014,494

(22) Filed: Jan. 26, 2011

(51) Int. Cl. C08G 73/10

(52) U.S. Cl. 525/431; 525/420

(57) ABSTRACT

A process for adjusting polyimide polymer properties includes combining monomers in a reaction mass to form a polyimide precursor. A property modifying moiety which is covalently bonded to an amine is then added to the reaction mass, and the reaction between the amine bonded to the property modifying moiety and the polyimide precursor is arrested before equilibrium. The polyimide precursor is imidized to form a polyimide polymer prior to equilibrium. The property modifying moiety can be evenly dispersed in the resulting polyimide polymer

### BACKGROUND OF THE INVENTION

1. Field of the Invention

The invention relates to polyimide polymers.

2. Background

Polyimides are an important class of polymeric materials and are known for many desirable performance properties. These properties include high glass transition temperatures, good mechanical strength, high Young's modulus, good UV durability, and excellent thermal stability. As a result of their favorable properties, polyimide compositions have become widely used in many industries, including the aerospace industry, the electronics industry and the telecommunications industry.

In the electronics industry, polyimide compositions are used in applications such as forming protective and stress buffer coatings for semiconductors, dielectric layers for multilayer integrated circuits and multi-chip modules, high temperature solder masks, bonding layers for multilayer circuits, final passivating coatings on electronic devices, and many others. In addition, polyimide compositions may form dielectric films in electrical and electronic devices such as motors, capacitors, semiconductors, printed circuit boards and other packaging structures. Polyimide compositions may also serve as an interlayer dielectric in both semiconductors and thin film multichip modules. The low dielectric constant, low stress, high modulus, and inherent ductility of polyimide compositions make them well suited for these multiple layer applications. Other uses for polyimide compositions include alignment and/or dielectric layers for displays, and as a structural layer in micromachining applications. Electronic components using polyimide films are used in many other industries.

In the aerospace industry, polyimide compositions are used for optical applications as membrane reflectors and the like. In application, a polyimide composition can be secured by a metal (often aluminum, copper, or stainless steel) or composite (often graphite/epoxy or fiberglass) mounting ring that secures the border of the polyimide compositions. Such optical applications may be used in space, where the polyimide compositions and the mounting ring are subject to repeated and drastic heating and cooling cycles in orbit as the structure is exposed to alternating periods of sunlight and shade.

Polyimides have many different uses in the industries named above, as well as in other industries. Other industries using polyimides include the automotive industry, the rail industry, the natural gas industry, and others. Polyimides can be used as high temperature adhesives, protective coatings or layers, membranes, gaskets, and a wide variety of other uses.

The increased complexity of the applications for polyimides has created a demand to tailor the properties of such polyimides for specific applications. Compounds or moieties incorporated into a polyimide or other polymer can change the properties of that polymer. For example, dyes can be added to a polymer to change the color, and ultra violet (UV) stabilizers can be added to increase resistance to damage from UV light. Many other compounds can be added to a polymer to change various properties.

Many different compounds can be added to polymers to change the polymer properties, and these compounds can be added in different ways. The added compounds can be covalently bonded to the polymer, dissolved or suspended in the polymer, or otherwise included in the polymer (such as with ionic bonding.) Often, an added compound will change more than one property, so controlling one property independently from a second property can be challenging. Some polymer uses require specific ranges for several different properties, and controlling the measured value of one property can compete with controlling the value of a different property.

### SUMMARY OF THE INVENTION

A process for producing polyimide polymers includes adding monomers to a reaction mass in a ratio that produces a first calculated average polymer chain length based on the ratio of the monomers used. The reaction mass is mixed and reacted to form an intermediate polyimide precursor. A property modifying moiety covalently bonded to an amine is then added to the reaction mass in a quantity that results in a second calculated average polymer chain length based on the total original monomers charged and the charge of the amine covalently bonded to the property modifying moiety. The reaction between the amine bonded to the property modifying moiety and the polyimide precursor is arrested prior to equilibrium, and the polyimide precursor is imidized to form a polyimide polymer. The property modifying moiety is evenly dispersed in the resulting polyimide polymer, and the actual average polymer chain length of the resulting polyimide polymer is between the first and second calculated average polymer chain lengths.

### BRIEF DESCRIPTION OF THE DRAWINGS

FIG. 1 depicts the formation of an amic acid from an anhydride and an amine.

FIG. 2 depicts the formation of an imide bond from an amic acid.

FIG. 3 depicts the formation of an amic salt from a tertiary amine and an amic acid.

FIG. 4 depicts an oligomeric silsesquioxane compound [OS].

FIG. 5 depicts a polyhedral shaped silsesquioxane compound [POSS].

NOTE: The use of waved lines “ [symbol] ” indicates the molecule continues, but does not necessarily repeat. The use of square brackets “[” and/or “]” indicates that the structure repeats beyond the bracket.

### DETAILED DESCRIPTION

### Polyimide

Polyimides are a type of polymer with many desirable properties. In general, polyimide polymers include a nitrogen atom in the polymer backbone, where the nitrogen atom is connected to two carbonyl carbons, such that the nitrogen atom is somewhat stabilized by the adjacent carbonyl groups. A carbonyl group includes a carbon, referred to as a carbonyl carbon, which is double bonded to an oxygen atom. Polyimides are considered an AA-BB type polymer because usually two different classes of monomers are used to produce the polyimide polymer. Polyimides can also be prepared from AB type monomers. For example, an aminodicarboxylic acid monomer can be polymerized to form an AB type polyimide. Monoamines and/or mono anhydrides can be used as end capping agents if desired.

One class of polyimide monomer is usually a diamine, or a diamine monomer. The diamine monomer can also be a diisocyanate, and it is to be understood that an isocyanate could be substituted for an amine in this description, as appropriate. There are other types of monomers that can be used in place of the diamine monomer, as known to those skilled in the art. The other type of monomer is called an acid monomer, and is usually in the form of a dianhydride. In this description, the term “di-acid monomer” is defined to include a dianhydride, a tetraester, a diester acid, a tetracarboxylic acid, or a trimethylsilyl ester, all of which can react with a diamine to produce a polyimide polymer. Dianhydrides are sometimes referred to in this description, but it is to be understood that tetraesters, diester acids, tetracarboxylic acids, or trimethylsilyl esters could be substituted, as appropriate. There are also other types of monomers that can be used in place of the di-acid monomer, as known to those skilled in the art.

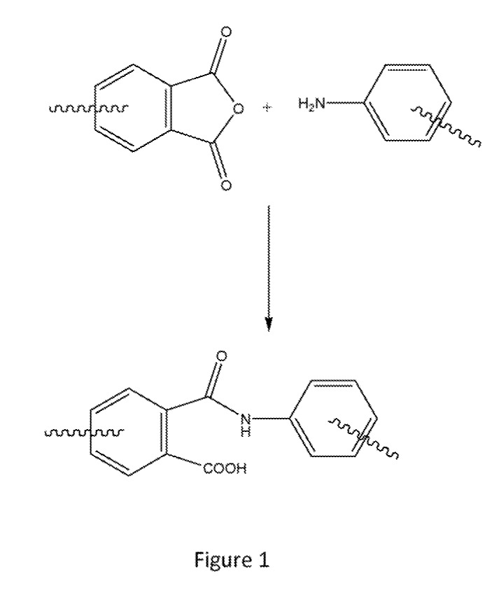

Because one di-acid monomer has two anhydride groups, different diamino monomers can react with each anhydride group so the di-acid monomer may become located between two different diamino monomers. The diamine monomer contains two amine functional groups; therefore, after the first amine functional group attaches to one di-acid monomer, the second amine functional group is still available to attach to another di-acid monomer, which then attaches to another diamine monomer, and so on. In this manner, the polymer backbone is formed. The resulting polycondensation reaction forms a polyamic acid. The reaction of an anhydride with an amine to form an amic acid is depicted in FIG. 1.

The polyimide polymer is usually formed from two different types of monomers, and it is possible to mix different varieties of each type of monomer. Therefore, one, two, or more di-acid monomers can be included in the reaction vessel, as well as one, two or more diamino monomers. The total molar quantity of di-acid monomers is kept about the same as the total molar quantity of diamino monomers if a long polymer chain is desired. Because more than one type of diamine or di-acid can be used, the various monomer constituents of each polymer chain can be varied to produce polyimides with different properties.

For example, a single diamine monomer AA can be reacted with two di-acid co-monomers, B₁B₁ and B₂B₂, to form a polymer chain of the general form of (AA-B₁B₁)ₓ-(AA-B₂B₂)_{y}, in which x and y are determined by the relative incorporations of B₁B₁ and B₂B₂ into the polymer backbone. Alternatively, diamine co-monomers A₁A₁ and A₂A₂ can be reacted with a single di-acid monomer BB to form a polymer chain of the general form of (A₁A₁-BB)ₓ-(A₂A₂-BB)_{y}. Additionally, two diamine co-monomers A₁A₁ and A₂A₂ can be reacted with two di-acid co-monomers B₁B₁ and B₂B₂ to form a polymer chain of the general form (A₁A₁-B₁B₁)_{w}-(A₁A₁-B₂B₂)ₓ-(A₂A₂-B₁B₁)_{y}-(A₂A₂B₂B₂)_{z}, where w, x, y, and z are determined by the relative incorporation of A₁A₁-B₁B₁, A₁A₁-B₂B₂, A₂A₂B₁B₁, and A₂A₂-B₂B₂ into the polymer backbone. More than two di-acid co-monomers and/or more than two diamine co-monomers can also be used. Therefore, one or more diamine monomers can be polymerized with one or more di-acids, and the general form of the polymer is determined by varying the amount and types of monomers used.

Polyimides may be synthesized by several methods. In the traditional two-step method of synthesizing aromatic polyimides, a solution of the aromatic diamine in a polar aprotic solvent, such as N-methylpyrrolidone (NMP), is prepared. A di-acid monomer, usually in the form of a dianhydride, is added to this solution, but the order of addition of the monomers can be varied. For example, the di-acid monomer can be added first, or the di-acid monomer and the diamine can be simultaneously added. The resulting polycondensation reaction forms a polyamic acid, also referred to as a polyamide acid, which is a polyimide precursor. Other polyimide precursors are known, including poly(amic ester) precursors, poly(amic acid) salt precursors, and polyisoimides. This process description may be applicable to one or more polyimide precursor solutions.

There are many examples of monomers that can be used to make polyimide polymers. A non-limiting list of possible diamine monomers comprises 4,4′-oxydianiline, 3,4′-oxydianiline, 3,3′-oxydianiline, p-phenylenediamine, m-phenylenediamine, o-phenylenediamine, diaminobenzanilide, 3,5-diaminobenzoic acid, 3,3′-diaminodiphenylsulfone, 4,4′-diaminodiphenyl sulfones, 1,3-bis-(4-aminophenoxy)benzene, 1,3-bis-(3-aminophenoxy)benzene, 1,4-bis-(4-aminophenoxy)benzene, 1,4-bis-(3-aminophenoxy)benzene, 2,2-Bis[4-(4-aminophenoxy)phenyl]-hexafluoropropane, 2,2-bis(3-aminophenyl)-1,1,1,3,3,3-hexafluoropropane, 4,4′-isopropylidenedianiline, 1-(4-aminophenoxy)-3-(3-aminophenoxy)benzene, 1-(4-aminophenoxy)-4-(3-aminophenoxy)benzene, bis-[4-(4-aminophenoxy)phenyl]sulfones, 2,2-bis[4-(3-aminophenoxy)phenyl]sulfones, bis(4-[4-aminophenoxy]phenyl)ether, 2,2′-bis-(4-aminophenyl)-hexafluoropropane, (6F-diamine), 2,2′-bis-(4-phenoxyaniline)isopropylidene, meta-phenylenediamine, para-phenylenediamine, 1,2-diaminobenzene, 4,4′-diaminodiphenylmethane, 2,2-bis(4-aminophenyl)propane, 4,4′ diaminodiphenyl propane, 4,4′-diaminodiphenyl sulfide, 4,4′-diaminodiphenylsulfone, 3,4′diaminodiphenyl ether, 4,4′-diaminodiphenyl ether, 2,6-diaminopyridine, bis(3-aminophenyl)diethyl silane, 4,4′-diaminodiphenyl diethyl silane, benzidine, 3,3′-dichlorobenzidine, 3,3′-dimethoxybenzidine, 4,4′-diaminobenzophenone, N,N-bis(4-aminophenyl)-n-butylamine, N,N-bis(4-aminophenyl)methylamine, 1,5-diaminonaphthalene, 3,3′-dimethyl-4,4′-diaminobiphenyl, 4-aminophenyl-3-aminobenzoate, N,N-bis(4-aminophenyl)aniline, bis(p-beta-amino-t-butylphenyl)ether, p-bis-2-(2-methyl-4-aminopentyl)benzene, p-bis(1,1-dimethyl-5-aminopentyl)benzene, 1,3-bis(4-aminophenoxy)benzene, m-xylenediamine, p-xylenediamine, 4,4′-diaminodiphenyl ether phosphine oxide, 4,4′-diaminodiphenyl N-methyl amine, 4,4′-diaminodiphenyl N-phenyl amine, amino-terminal polydimethylsiloxanes, amino-terminal polypropyleneoxides, amino-terminal polybutyleneoxides, 4,4′-Methylenebis(2-methylcyclohexylamine), adipic acid, 1,9-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, and 4,4′-methylenebisbenzeneamine. A non-limiting list of possible diacid monomers comprises hydroquinone dianhydride, 3,3′,4,4′-biphenyl tetracarboxylic dianhydride, pyromellitic dianhydride, 3,3′,4,4′-benzophenone tetracarboxylic dianhydride, 4,4′-oxydiphthalic anhydride, 3,3′,4,4′-diphenylsulfone tetracarboxylic dianhydride, 4,4′-(4,4′-isopropylidenediphenoxy)bis(phthalic anhydride), 2,2-bis(3,4-dicarboxyphenyl)propane dianhydride, 4,4′-(hexafluoroisopropylidene)diphthalic anhydride, bis(3,4-dicarboxyphenyl) sulfoxide dianhydride, polysiloxane-containing dianhydride, 2,2′,3,3′-biphenyltetracarboxylic dianhydride, 2,3,2′,3′-benzophenonetetracarboxylic dianhydride, 3,3′,4,4′-benzophenonetetracarboxylic dianhydride, naphthalene-2,3,6,7-tetracarboxylic dianhydride, naphthalene-1,4,5,8-tetracarboxylic dianhydride, 4,4′-oxydiphthalic dianhydride, 3,3′,4,4′-biphenylsulfone tetracarboxylic dianhydride, 3,4,9,10-perylene tetracarboxylic dianhydride, bis(3,4-dicarboxyphenyl)sulfide dianhydride, bis(3,4-dicarboxyphenyl)methane dianhydride, 2,2-bis(3,4-dicarboxyphenyl)propane dianhydride, 2,2-bis(3,4-dicarboxyphenyl)hexyfluoropropane, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-,8,9,10-tetracarboxylic dianhydride, pyrazine-2,3,5,6-tetracarboxylic dianhydride, benzene-1,2,3,4-tetracarboxylic dianhydride, and thiophene-2,3,4,5-tetracarboxylic dianhydride.

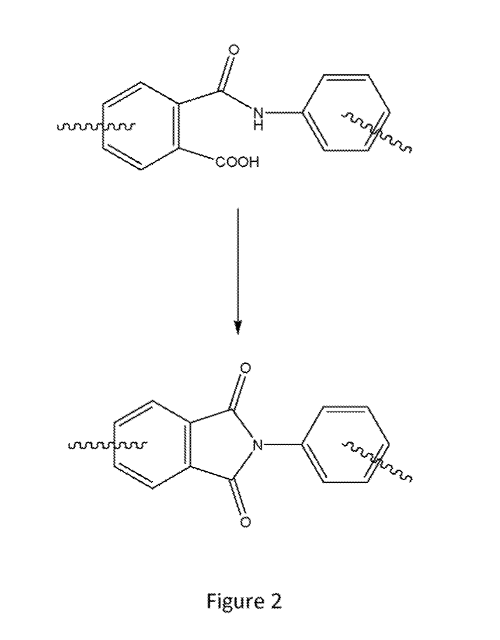

A polyamic acid is soluble in the reaction solvent and, thus, the solution may be cast into a film on a suitable substrate such as by spin casting, gravure coating, three roll coating, knife over roll coating, slot die extrusion, dip coating, or other techniques. The cast film can then be heated in stages to elevated temperatures to remove solvent and convert the amic acid functional groups in the polyamic acid to imides with a cyclodehydration reaction, also called imidization. “Imidization” is defined as the conversion of a polyimide precursor into an imide. Alternatively, some polyamic acids may be converted in solution to polyimides by using a chemical dehydrating agent, catalyst, and/or heat. The conversion of an auric acid to an imide is shown in FIG. 2, with continuing reference to FIG. 1.

Many polyimide polymers are produced by preparing a polyamic acid polymer in the reaction vessel. The polyamic acid is then formed into a sheet or a film and subsequently processed with heat (often temperatures higher than 250 degrees Celsius) or both heat and catalysts to convert the polyamic acid to a polyimide. However, polyamic acids are moisture sensitive, and care must be taken to avoid the uptake of water into the polymer solution. Additionally, polyamic acids exhibit self-imidization in solution as they gradually convert to the polyimide structure. The imidization reaction generally reduces the polymer solubility and produces water as a by-product. The water produced can then react with the remaining polyamic acid, thereby cleaving the polymer chain. Moreover, the polyamic acids can generally not be isolated as a stable pure polymer powder. As a result, polyamic acids tend to have a limited shelf life. Shelf life can be extended by storing a polyamic acid at reduced temperatures. For example, shelf life can be increased by storing a polyamic acid at temperatures less than −20 centigrade.

### Adjusting Polyimide Properties

The characteristics or properties of the final polymer are significantly impacted by the choice of monomers which are used to produce the polymer. Factors to be considered when selecting monomers include the properties of the final polymer, such as the flexibility, thermal stability, coefficient of thermal expansion (CTE), coefficient of hydroscopic expansion (CHE) and any other properties specifically desired, as well as cost. Often, certain important properties of a polymer for a particular use can be identified. Other properties of the polymer may be less significant, or may have a wide range of acceptable values; so many different monomer combinations could be used. For example, it is important for a polymeric protective cover of a windshield to be clear, but it may be less important for the polymer to be resistant to attack from atomic oxygen. In another example to be further explored, a polymer may be desired with a CTE within a first range, which could be between 15 and 20 parts per million per degree centigrade (ppm/C), or more preferably with a CTE between 16 and 18 ppm/C. Additionally, while controlling the CTE to within the desired first range, the CHE also needs to be controlled within a desired second range, which could be a value as low as possible, but at least less than 16 parts per million per percent relative humidity (ppm/% RH), or more preferably less than 10 ppm/% RH, or even more preferably less than 8 ppm/% RH. Other properties of the polymer may be less important or easily obtained.

The CTE and CHE of a polymeric article depend somewhat on the physical size and shape of the article, as well as the temperature range and relative humidity range for the measurement. For example, the CTE and CHE can be lower for 2 micron thick film of a specified polymer than for a 150 micron thick film of the same polymer. All references in this description to the CTE or CHE of a polymer refer to the CTE and CHE of that polymer under consistent, standard testing conditions. In this description, the CTE and CHE of a polymer is measured for a flat film with a width of 4.9 mm, and a length of 16 mm, a thickness between about 2 microns and about 150 microns, depending on the thickness of the test article, where the thickness varies no more than 5% within the test sample. The CTE is measured for a temperature change between 20 degrees centigrade (° C.) to 50° C. in a dry nitrogen atmosphere, and the CHE is measured for a relative humidity change between 20% relative humidity to 80% relative humidity at 23° C.

Other factors to be considered in the selection of monomers include the expense and availability of the monomers chosen. Commercially available monomers that are produced in large quantities generally decrease the cost of producing the polyimide polymer film since such monomers are in general less expensive than monomers produced on a lab scale and pilot scale. Additionally, the use of commercially available monomers improves the overall reaction efficiency because additional reaction steps are not required to produce a monomer which is incorporated into the polymer.

Most polyimides are comprised of relatively rigid molecular structures such as aromatic/cyclic moieties. These typical structures are often relatively linear and stiff. The linearity and stiffness of the cyclic/aromatic backbone reduces segmental rotation and allows for molecular ordering which results in lower coefficients of thermal expansion (CTE) than many thermoplastic polymers having more flexible chains. In addition, the intermolecular associations of polyimide chains provide resistance to most solvents, which tends to reduce the solubility of many typical polyimide polymers in many solvents. The use of aliphatic monomers can reduce the stiffness of the polymer, if desired.

Polyimide polymers have a backbone, where the polymer backbone includes the string of atoms that form a chain from one end of the polymer to the other. Some compounds or sub-compounds which are not part of the polymer backbone can still be linked to the polymer. A tether refers to a molecular chain that is used to connect the polymer backbone to another compound, moiety, or sub-compound. A compound can be connected directly to the polymer backbone, or the compound can be connected using a tether.

Some compounds can be incorporated into a polyimide without being covalently connected to the polymer. For example, a compound can be dissolved or suspended in the polyamic reaction mass, and can then become entrapped in the polyimide during and after imidization. Often, compounds which are dissolved or suspended will tend to aggregate, so the final polyimide has areas where the compound is phase-separated into domains of higher concentrations of the compound, and other domains where the compound is less concentrated. Polyimide films that are otherwise transparent or translucent can include phase domains of a high enough concentration of a compound with sufficiently large diameters to exhibit light scattering manifesting in a hazy appearance. One way to determine if a compound includes aggregated is to examine the level of haze in the film as compared to the polyimide film without any compound. The presence of a haze tends to indicate macroscopic aggregated domains. Phase separation of a compound into domains of higher concentration with diameters sufficiently large to produce a haze is considered a macroscopic effect in this description, and therefore indicates the compound is not considered to be evenly distributed. The exact size of aggregated domains can vary somewhat for different compounds.

Specific properties of a polyimide can be influenced by incorporating certain compounds into the polyimide. The selection of monomers is one way to influence specific properties. Another way to influence properties is to add a compound or property modifying moiety to the polyimide. It can be difficult to covalently bond a compound along the length of a polymeric chain, and the total quantity of material added at the end of a polymeric chain is limited. The quantity of a compound that can be added to a polymer by dissolution or suspension can also be limited, because many compounds have limited solubility, and compounds in suspension tend to agglomerate into an uneven distribution in the polymer. An evenly dispersed compound or property modifying moiety is generally preferred to an unevenly dispersed compound or property modifying moiety because the polymer properties are more consistent with even dispersion. In this description, the term “evenly dispersed” means one compound or moiety is evenly dispersed in a polymer, solution, or reaction mass on a macroscopic level. The haze value of a transmissive sample is the ratio of the intensity of scattered light to the intensity of total transmitted light. An evenly dispersed compound generally results in a haze value of less than 5%, and an Unevenly dispersed compound generally results in a haze value of 5% or more. In this description, a compound is considered evenly dispersed in a polymer, solution, or reaction mass if a light path length of 8 to 12 microns produces a haze value of less than 5%. It is understood that there may be clusters on a microscopic level, even if a compound is evenly dispersed on a macroscopic level.

### Average Polymer Chain Length

The diamine and the acid monomer are generally added in approximately a 1:1 molar stoichiometry. Adding the diamine and acid monomer in other ratios can change the average chain length of the resulting polymer. In general, polymerization reactions conducted with stoichiometries outside of essentially a 1:1 molar ratio of the monomers reduces the average polymer chain length as predicted by the Carothers equation and verified extensively in practice. Additionally, increasing deviations from the 1:1 molar ratio of reacting difunctional monomers generally results in lower average polymer chain length. For example, a molar ratio of 2:1 will produce an average of 3 monomers incorporated into the resulting polymer because a first type of monomer is available for each of the 2 functional groups on the second type of monomer. So, a molar ratio of 2:1 produces a calculated average polymer chain length of 3 monomers. A molar ratio of 2:3 will produce an average of 5 monomers incorporated into the resulting polymer, and so on.

A longer polymer chain improves the mechanical toughness and durability of the final film up to a critical molecular weight above which additional increases in molecular weight do not provide substantial additional increases in mechanical toughness and durability. Improved mechanical toughness and durability are desirable in many circumstances. For many applications, there is a minimum useful chain length, where the chain length is a measure of the average length of the polymeric chains. Polymer chain length can impact the polymer properties, and different final products require different polymer properties. For a given final product made from a polymer, the polymer properties are unsatisfactory if the average chain length falls below the minimum useful chain length, so the minimum useful chain length can vary from one final product to another. However, the minimum useful chain length can be similar or the same for many different final products, and basic polymer properties are often advertised where the properties depend on the average chain length exceeding a specified minimum useful chain length.

For most final products, an average chain length that exceeds the minimum useful chain length is acceptable, but an average chain length less than the minimum useful chain length is not acceptable. An example may clarify the meaning of the minimum useful chain length. The polyimide polymer CPI, which is made from the monomers 4,4′-(hexafluoroisopropylidene) diphthalic anhydride (6FDA) and 2,2′-bis-(4-aminophenyl)-hexafluoropropane (4-BDAF), has a minimum useful chain length of between about 40,000 and 80,000 atomic mass units for many applications. A user could specify a specific value of 60,000 atomic mass units, for example, as the minimum useful chain length, and only polyimide batches with an average chain length of at least 60,000 would be accepted. As with many specifications, an exact value that clearly defines acceptable values for the desired application is difficult to define, but one can select a value that does produce acceptable results and use that value as a product specification.

Longer average chain lengths tend to increase viscosity of polyamic acid solutions, so the viscosity of a polyamic acid solution with a predefined quantity of a specified solvent can be used to verify the resulting polyimide polymer will exceed the minimum average chain length. The viscosity can be decreased by adding more solvent, surfactants, or other compounds, so the viscosity that corresponds to a set minimum average chain length depends on the composition of the polyamic acid solution. Accordingly, reactions which reduce the average chain length tend to reduce the viscosity of the polyamic acid solution, so the progress of the reaction can be followed by tracking the viscosity.

The Carothers equation describes the number-average degree of polymerization X̅ₙ to be equal to (1+r)/(1+r−2rp) where r is known as the stoichiometric imbalance and p is the extent of polymerization. The stoichiometric imbalance is equal to the number of functional groups of one reactive species (for example, the amine based monomer) divided by the number of functional groups of the other reactive species (for example, the anhydride based monomer). The stoichiometric imbalance is defined such that the value is always less than or equal to one. The diamine and the di-acid monomer are generally added in approximately a 1:1 molar stoichiometry in order to form a relatively high polymer chain length polymer, but can be added in other ratios, including stoichiometries including or between any of the following: 0.80:1, 0.85:1, 0.90:1, 0.95:1, 0.97:1, 0.98:1, 0.99:1, 0.995:1, 1.005:1, 1.01:1, 1.02:1, 1.03:1, 1.05:1, 1.1:1, and 1.15:1, and 1.20:1.

It is well known to artisans of ordinary skill that monofunctional reactants, such as monoamines and monoanhydrides in the case of polyimides, can be used to limit the polymer chain length of a step growth polymer, such as a polyimide, during synthesis by endcapping the growing polymer chain. This technique has been disclosed in various reports describing the synthesis of polyimides. The term “endcapper” means a monofunctional reactant in this description. The use of monofunctional reagents also serves to redefine the stoichiometric imbalance, which now is equal to the number of functional groups of one reactive difunctional species (for example, the diamine) divided by the number of functional groups of the other reactive difunctional species (for example, the dianhydride) plus twice the number of functional groups of the monofunctional species initially present (for example, a monofunctional anhydride). Accordingly, a reduction in chain length resulting from the use of monofunctional reactants is anticipated. These monofunctional reactants tend to cap the end of a polymeric chain, so they can be referred to as endcappers.

The addition of primary amine monofunctional reactants to a polyamic acid already formed by combining the diamine and di-acid monomers is known to reduce the polymer chain length and average molecular weight. Lower average polymer chain lengths generally result in lower average molecular weights for a polymer. Regardless of whether the amine monofunctional reactant is added before, during, or after the di-functional monomer charges, the final equilibrium average chain length is predicted to be the same by the Carothers equation.

The functionality of the endcapper may be varied for specific purposes, including post-polymerization reactions and de-activating reactive end groups. In the case of end groups on the polymeric backbone that provide additional functionality, it may be desirable to incorporate an amount of the monofunctional species in excess of the amount that can be attached to the end of the propagating polymer chain. However, in some embodiments, it is desirable to limit the amount of monofunctional species present for at least two reasons. Firstly, in the case when amine monofunctional reactants are used to limit the polymer chain length, an increase in the amount of amine monofunctional reactants incorporated is accompanied by a reduction in polymer chain length. Since there is a critical polymer chain length for most polyimide applications below which there is a substantial degradation in certain mechanical properties, the amount of amine monofunctional reactant which can be incorporated is limited. Additionally, any reactions which reduce the chain length below the minimum useful chain length are not desired. In the case when the endcapper is attached to the termini of existing higher polymer chain lengths, the amount that can be incorporated is limited by the number of functional end groups remaining, which is generally small in comparison with the number of monomers incorporated into the polymer. Additional endcappers will either not react with the polymer chain, or they can serve to sever and shorten the polymer chains.

### Property Modifying Moiety Incorporation into a Polyamic Acid

The addition of a primary mono amine to a polyamic acid can result in a lower polymer chain length. The acid monomer reacts with amines to form amic acids. The amines for this reaction are typically located on the diamine monomer, but other amines will also participate in this reaction. If the polyamic acid polymer is formed, and then an amine is added, the reaction mass will proceed toward an equilibrium where the portion of the polymer formed by the di-acid monomer combines in various proportions with the portion of the polymer formed from the diamine monomer and the amine added at a later stage. If the amine added at a later stage is a monoamine, this can serve to reduce the polymer chain length and is evidenced by a decrease in solution viscosity, because longer actual polymer chain lengths usually have higher viscosities. The proportion of acid functional groups that react with the amines will depend on the relative reactivity of the amines towards the acid functional group, where the term “acid functional group” refers to the functional group from the original di-acid monomer. An amine covalently bonded to a phenyl group tends to be less reactive towards acid functional groups than an amine at the end of an aliphatic chain because of the stabilization effect of the phenyl group which decreases the nucleophilicity of the nitrogen atom.

An amine can be added to a polyamic acid, where the amine is connected to a desired property modifying moiety. The property modifying moiety may be a compound that will impart a desired property to the polyimide if added in sufficient quantity. The amine can be a mono amine, but it is also possible to use a diamine or a compound with more than 2 amino groups. The property modifying moiety, when not connected to the amine, may be a property modifying moiety that will not dissolve in the polyamic acid at high enough concentrations to impart the desired property, or that will aggregate into an uneven distribution upon curing of the polyamic acid into a solid polyimide article. In either case, the addition of high concentrations of the desired property modifying moiety to the polyamic acid, when the property modifying moiety does not include a primary amine, would typically result in an uneven distribution in the polyimide polymer, as evidenced by unacceptable levels of haze and/or brittleness.

The amine added with the attached property modifying moiety, which is referred to as the “moiety amine” in this description, forms part of the total stoichiometric ratio of amines to anhydrides. As discussed above, the total stoichiometric ratio of amines to anhydrides can be used to estimate the average polymer chain length at equilibrium. Providing a reaction mass with excessive moles of amines relative to the moles of anhydrides tends to produce lower molecular weight polymer chains than a reaction mass with approximately equal molar quantities of amines and anhydrides.

In this discussion, the first calculated average polymer chain length is the average polymer chain length calculated using only the ratio of diamine and di-acid monomers used to produce the polyamic acid before the addition of the moiety amine connected to a desired property modifying moiety. The second calculated average polymer chain length is the average polymer chain length calculated with all amines and di-acid monomers added, or the average polymer chain length calculated after the moiety amine is added to the polyamic acid.

It has been found that the property modifying moiety can be evenly dispersed in the polyimide polymer and the average polymer chain length of the resulting polymer is not substantially reduced if one arrests the chemical reaction between the moiety amine and the polyamic acid prior to equilibrium. Arresting the chemical reaction means stopping or slowing the reaction such that the reaction never reaches equilibrium. The actual average polymer chain length is between the first and second calculated average polymer chain lengths, and can be nearer the first calculated average polymer chain length than the second calculated average polymer chain length.

It is not known for certain how the moiety amine and the desired property modifying moiety are incorporated into the resulting polyimide polymer. The connection may be by a covalent bond, an ionic bond, by making the property modifying moiety more soluble in the polyamic acid, or by other phenomena. It has been discovered that connecting the property modifying moiety to a moiety amine produces a polyimide with reduced haze, as compared to adding the property modifying moiety without the connected moiety amine. The reduced haze indicates the property modifying moiety is evenly dispersed in the polymer.

Several techniques can be used to arrest the reaction and prevent equilibrium after the moiety amine is added to the polyamic acid. In one embodiment, the polyamic acid is cooled to below a control temperature within a control time after the addition of the moiety amine to the polyamic acid. The reduced temperature slows the reaction rate, so the temperature should be reduced before the reaction has proceeded to equilibrium. The control time and control temperature will depend on the specific compounds involved. The resulting polyamic acid can be stored at a reduced temperature for some time, but it will gradually degrade over time. To obtain better results, the resulting polyamic acid should be imidized to a polyimide before an expiration date.

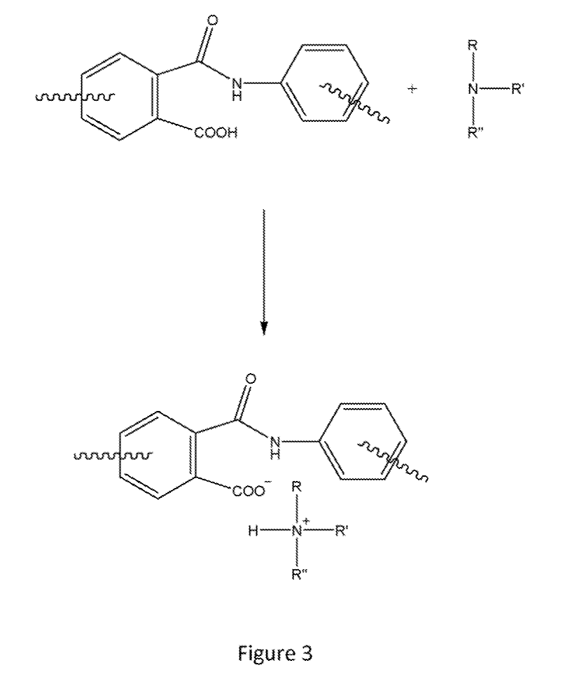

In an alternate embodiment, a tertiary amine can be used to hinder chemical equilibrium between the moiety amine and the polyamic acid. The moiety amine can be a primary amine, and the use of a primary amine for the moiety amine has produced better results in some tests. Addition of a tertiary amine to the polyamic acid produces an amic salt from the amic acid, as shown in FIG. 3. It has been found that adding a tertiary amine to the polyamic acid prior to adding a molar excess of moiety amine can reduce the rate at which the polymer chain is shortened by the primary moiety amine in the chain scission reaction. The reaction rate is dependent on temperature, so lowering the temperature sufficiently can slow or essentially stop the chain scission reaction. The addition of a tertiary amine prior to the addition of a primary moiety amine is an alternate way to slow equilibrium. Cooling the reaction mass to less than a control temperature within a control time of adding the moiety amine can further slow the reaction and delay equilibrium. Use of a tertiary amine, as described, can increase the control time and/or the control temperature.

The formation of the polyamic salt provides the polymer chain with enough stability to at least slow the rate of the chain scission reactions by the moiety amine. The order of addition of the tertiary amine and the moiety amine can be important. It has been found that the addition of a primary moiety amine prior to the addition of the tertiary amine can produce a polyimide which behaves as though the reaction between the moiety amine and the polyamic acid reached equilibrium. If the reaction between the moiety amine and the polyamic acid reaches equilibrium, the average actual polymer chain length is approximately equal to the second calculated average polymer chain length predicted by the total molar ratio of the primary amines to the anhydrides present in the reaction mass. The primary amines for this ratio include the diamine monomer amines and the primary moiety amine. Simply changing the order of addition so the tertiary amine is added to the reaction mass prior to the moiety amine can produce a polymer which behaves as though the actual average polymer chain length were longer than the second calculated average polymer chain length. Several factors can influence this, including the relative reactivity of the moiety amine and the diamine monomer, the reaction time before the reaction mass is chilled, the reaction temperature before the reaction mass is chilled, the degree of steric hindrance of the tertiary amine, and other factors as well.

The tertiary amine used to form the polyamic salt can be functional for the overall polymer. For example, the tertiary amine can be a cross linking agent in a photopackage, such as 2-(diethylamino)ethyl methacrylate (DEAEMA) or 2-(dimethylamino)ethyl methacrylate (DMAEMA). In this example, the tertiary amine includes a double bond which can serve as a cross linking agent. Other tertiary amines which include double bonds could also be used, and could also could serve as a cross linking agent. The tertiary amine can also be an additive or part of an additive that influences other properties of the final resulting polyimide.

Reducing the nucleophilicity of the moiety amine prior to mixing with the polyamic acid is another embodiment to slow the reaction rate and help prevent equilibrium. One way to accomplish this is by forming a protected amino species that reforms a primary amine from the protected moiety amine upon thermal imidization. Imidization can also be called “curing.” This can be done by reacting a primary moiety amine with a protecting group prior to addition to the polyamic acid, where the bond between the protecting group and the moiety amine does not withstand the conditions encountered during imidization. So, the moiety amine is not a free primary amine when added to the polymeric reaction mass, but a reaction occurs that re-forms a primary amine from the moiety amine under the conditions used to cure the polyamic acid to form the polyimide polymer. For example, the reaction of a primary moiety amine with a protic acidic species, such as acetic acid, improves the viscosity stability of the resultant polyamic acid solution and results in a homogeneous polyimide film upon curing. Improved viscosity stability and a homogenous film upon curing are indications that the polymer chain length is above a set level and the property modifying moiety is evenly dispersed in the polymer.

Di-tert-butyl dicarbonate (DTBDC) is another protecting group that can be used to protect a primary moiety amine. Reacting the primary moiety amine with di-tert-butyl dicarbonate to form a tertiary butyloxy carbamate (BOC) protected amine is effective at maintaining viscosity stability and results in a homogeneous polyimide film upon curing. There are many different protecting groups that can be used, and different conditions can separate the protecting group form the primary moiety amine, as is known by those skilled in the art. The use of protecting groups is an alternate method to arrest the reaction between the moiety amine and the polyamic acid and prevent equilibrium.

In contrast, the conversion of the moiety amine to an amide by reaction with acetyl chloride, or to an imide by reaction with phthalic anhydride, is effective at maintaining viscosity stability, but does not result in a homogeneous film upon curing. Neither the amide nor imide will convert to a primary amine under the conditions used to cure the polyamic acid. The fact that the viscosity remains stable indicates the average polymer chain has not fallen below a set length, which means the amide or imide formed from the moiety amine did not react with the polyamic acid and shorten the average polymer chain length. However, the fact that a homogeneous film is not obtained indicates compounds other than solvents and polymer were present in the reaction mass. It would appear the amide or imide that was added to the polyamic acid was not evenly dispersed. The non-homogeneous film also indicates the property modifying moiety is not evenly dispersed in the polymer.

Several techniques have been described to prevent or delay equilibrium after adding an amine to a polyamic acid. These different techniques can generally be used in isolation, or used in combination, as desired. Combining different techniques can help prevent or slow equilibrium even more than using one technique in isolation. The ability to add different property modifying moieties to a polyimide polymer may allow for adjustment of many different polyimide properties, including:

Thermal Properties
Coefficient of thermal expansion (CTE)
Melt temperature
Glass transition temperature
Heat Capacity
Thermal conductivity
Thermal stability
Thermo oxidative stability

Other Properties
Moisture uptake
Coefficient of moisture expansion (CME)
Coefficient of hygroscopic expansion (CHE)
Photosensitivity
Transport of small penetrant molecules
Imparting durability to atomic oxygen, ozone, reactive ions, electrons, protons, alpha particles, or other gaseous, ionic, liquid, or plasma species
Imparting flame retardance

Processing Properties
Melt flow processing
Providing sites for post-processing cross-linking
Pigment compatibility
Blend compatibility

Mechanical Properties
Elastic Modulus
Improving low temperature or cryogenic flexibility
Elasticity

Optical Properties
Color
Light scattering
UV Cutoff
UV properties
IR properties
Refractive index

Topological Properties
Surface roughness
Surface Energy

Solution Properties
Solubility
Surface tension
Viscosity
Dilute solution viscosity
Solution clarity
Spray properties
Gelling properties
Surfactant properties
Flow properties
Leveling properties
Drying properties

Electrical Properties
Dielectric constant
Dissipation factor
Electrical conductivity or resistivity
Magnetic properties

One skilled in the art will recognize the value of a new technique for adding property modifying moieties to a polymer.

### EXAMPLES

The process described above can be used to introduce a wide variety of compounds or moieties to a polymer. These moieties can be added to influence a particular physical property of the polymer. Detailed below are two non-limiting examples of specific properties which can be influenced by adding moieties to a polymer. As would be understood by one skilled in the art, other physical properties could be influenced by adding the same or different moieties to polyimide polymers.

### Example 1

### CTE and CHE Control

In one embodiment, a polyimide polymer with a controlled coefficient of thermal expansion (CTE) and a controlled coefficient of hydroscopic expansion (CHE) is desired. The desired properties for this example are a CTE in the range of 15 to 18 ppm/° C. (part per million per degree centigrade), and a CHE as low as possible, but at least less than 16 ppm/% RH (part per million per percent relative humidity,) more preferably less than 10 ppm/% RH, and even more preferably less than 8 ppm/% RH. The polyimide precursor may also be photosensitive.

### Control of CTE

Microelectronic devices often include multilayer structures with alternating layers of conductors, such as metals or semiconductors, isolated by layers of dielectric insulators, such as polyimides. In order to manufacture such devices, multiple high temperature heating and cooling cycles may be required. Additionally, during operation, the devices may heat and experience significant heating and cooling cycles. As a result, the conductors and the dielectric insulators experience multiple cycles of heating and cooling, often covering temperature ranges of 350 degrees Celsius or more during manufacturing. The heating and cooling cycles generate stresses as a result of differences in CTE values and other variables between the different layers. These stresses may cause deformations, delaminations, and/or cracks which can degrade the performance of the device and/or lead to premature failure. In certain applications, it is desirable to control the CTE of the polyimides so that the CTE value of the polyimide is matched as closely as possible to the CTE value of the substrate in the device. The similar CTE values of the polyimide and adjacent or nearby components can mitigate thermal stresses associated with thermal cycling.

The selection of monomers affects the resultant CTE of the cured polyimide. The properties of the monomers that are known to affect the CTE include the monomer flexibility, monomer linearity, and the presence of bulky substituents. The flexibility of a monomer refers to the amount of movement available to one portion of the monomer without requiring movement from another portion of the monomer. For example, pyromellitic dianhydride (PMDA), as shown below, has very little flexibility.

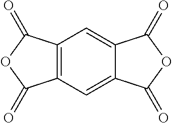

However, 4,4′-oxydiphthalic anhydride (ODPA), as shown below, is more flexible than PMDA due to the presence of the ether linkage. In ODPA, one anhydride group can rotate about the ether bond without requiring movement of the other anhydride group. A rigid polyimide backbone is comprised of primarily rigid monomers, while a flexible polyimide backbone is comprised of primarily flexible monomers.

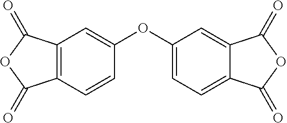

The linearity of a molecule is usually decreased by non-linear linkages in the polymer backbone. Ortho or meta linkages on phenyl groups in the polyimide backbone tend to result in a higher CTE, as well as greater solubility and a higher CHE. For example, p-phenylene diamine (p-PDA), as shown below, is a relatively linear unit.

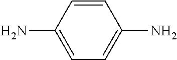

However, m-phenylene diamine (m-PDA), as shown below, contains a meta linkage, which reduces the linearity of the resultant polyimide backbone.

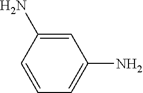

A linear backbone is comprised primarily of monomers providing linear linkages. For example, 3,3′,4,4′-biphenyltetracarboxylic dianhydride (symmetric BPDA or s-BPDA) provides a linear unit when incorporated into a polyimide backbone, while BPDA isomers such as 2,3,3′,4′-BPDA (asymmetric BPDA or a-BPDA) and 2,2′,3,3′-BPDA (i-BPDA) do not. In general, both rigid monomers and linear monomers tend to decrease the CTE of the resultant polyimide.

Since many factors that result in an increase in CHE also result in an increase in CTE, and many factors that result in a decrease in CHE also result in a decrease in CTE, it can be difficult to adjust the CHE to within a prescribed range without effecting a change in CTE. Some polyimides can be produced with a CHE of less than 8 ppm/% RH, but the corresponding CTE is low, close to zero, or negative. For example, a polyimide of s-BPDA/p-PDA exhibits a CHE of approximately 6 ppm/% RH and a CTE of approximately 4-6 ppm/° C. In another example, a polyimide of PMDA/2,2′-dimethylbenzidine (DMB) exhibits a CHE of approximately 7 ppm/% RH and a CTE of approximately −5 ppm/° C. In our example, we desire both a higher CTE and a low CHE.

Bulky substituents are moieties that tend to interfere with intramolecular and intermolecular chain association because of their size. The bulky substituents can be included between phenyl groups in the polymer backbone, they can be connected directly to a phenyl group, they can be tethered or directly bonded to the polyimide backbone, they can be dispersed through the polymer either in solution or suspension, or they can be included in the polyimide in other ways. There can be ionic bonds, hydrogen bonds, covalent bonds, other attractions, or essentially no chemical interaction between a substituent and the polymer. The bulky substituents tend to reduce the ability of adjacent polymer chains to tightly associate. This tends to allow other molecules to enter between adjacent polymer chains, which also tends to increase the polymer solubility. Bulky substituents in rigid polyimides tend to increase the overall polymer CTE by disrupting packing and ordering, and providing additional free volume. However, bulky substituents in flexible polyimides may decrease segmental mobility and serve to reduce the bulk polyimide CTE.

### Control of Polymer CHE

The coefficient of hydroscopic expansion (CHE) is a measurement of the dimensional change in response to a given change in the environmental relative humidity. So, the CHE can be measured by measuring the percent change in length of a polymer sheet when the relative humidity around the polymer sheet is changed. In some cases, it is important that a polymer does not expand or contract beyond specified limits throughout a specified change in environmental relative humidity. The selection of monomers used to produce a polyimide can impact the CHE of a polyimide.

The same factors that reduce the CTE of a polyimide also tend to reduce the CHE of a polyimide, but the CHE is also affected by some additional factors. One factor which tends to affect the CHE of a polymer is the moisture uptake of the polymer. A polyimide may contain many polar moieties which have an affinity for water, referred to as hydrophilic groups. A polyimide may also contain other moieties which lack an affinity for water, referred to as hydrophobic groups. Incorporation of hydrophobic moieties into a polyimide may serve to reduce the CHE by reducing the moisture uptake in response to changes in environmental humidity. Some compounds which tend to be hydrophobic include fluorinated carbon atoms and aliphatic carbons. Fluorinated compounds tend to be bulky and tend to include flexible linkages, both of which increase the CTE. The bulky and flexible aspect of fluorinated groups tends to increase the CHE, but the hydrophobic aspect tends to lower CHE. The overall effect of fluorinated groups on the resultant CHE is dependent on the molecular architecture of the fluorinated groups and the rest of the polyimide.

In a similar manner, several different bulky moieties can be used to influence the CHE and CTE. Table 1 below shows the results for two such moieties with various polyimide polymers. A polyimide made from 2,2′-dimethylbenzidine (DMB) with a 50/50 ratio of pyromellitic dianhydride (PMDA) and 4,4′-biphenyldianhydride (BPDA) with 40 weight percent 2,4,6-tribromoaniline (TBA) produces the desired CHE and CTE specified above. The desired CTE range was between 15 and 18, and the desired CHE range was as low as possible, but at least lower than 16, more preferably less than 10, and most preferably less than 8. The values for this specific example, as seen in Table 1, are a CHE of 3.2 and a CTE of 15.2. It is theorized that other bulky, hydrophobic compounds combined with a rigid polyimide backbone can lower the CHE, and increase the CTE. Theory therefore supports the use of these other large, hydrophobic compounds with a polyimide backbone to lower CHE with either an increase in the CTE, or with a less significant lowering of the CTE as compared to the CHE. Other compounds which theoretically could be used to control CHE and CTE include adamantanes, fullerenes, and other halogenated and non-halogenated aliphatic and aromatic compounds.

There are situations in which a polyimide polymer with a high CHE is desired, such as for uses in certain moisture sensors. One would expect the inclusion of large hydrophilic compounds into the polymer would increase the CHE. The technique of this description may allow a chemist to disproportionately increase the CHE of a polymer relative the CTE, and thereby produce a polymer with specific desired properties. Many other polymer property variations could also be conceived.

TABLE 1

| | | Added property | Moiety | | |
|---|---|---|---|---|---|
| Diamine | Di-acid | modifying | concentration | CHE | CTE |
| monomers* | monomers* | moiety* | (w/w) | (ppm/% RH) | (ppm/° C.) |
| DMB | BPDA | None | 0% | 10.9 | 6.4 |
| DMB | BPDA | Isobutyl POSS | 20% | 8.5 | 12.1 |
| DMB | PMDA | None | 0% | 7.2 | −5.2 |
| DMB | PMDA | Isobutyl POSS | 20% | 5.9 | −2.6 |
| DMB (50%) | BPDA | None | 0% | 8.7 | 3.1 |
| TFMB (50%) | | | | | |
| DMB (50%) | BPDA | Isobutyl POSS | 20% | 5.6 | 28.1 |
| TFMB (50%) | | | | | |
| DMB (50%) | PMDA | None | 0% | 11.0 | −4.0 |
| TFMB (50%) | | | | | |
| DMB (50%) | PMDA | Isobutyl POSS | 20% | 4.6 | N/A |
| TFMB (50%) | | | | | |
| DMB | PMDA (50%) | TBA | 40% | 3.2 | 15.2 |
| | BPDA (50%) | | | | |
| DMB (96%) | BDPA (90%) | TBA | 35% | 11.2 | 22 |
| pPDA (4%) | 6FDA (10%) | | | | |
| DMB (96%) | BPDA (90%) | TBA | 2% | 12.8 | 22 |
| pPDA (4%) | 6FDA (10%) | | | | |

*DMB: 2,2′-Dimethylbenzidine; BPDA: 4,4′-biphenyldianhydride; POSS: Polyhedral oligomeric silsesquioxane, PMDA: pyromellitic dianhydride; TFMB: 2,2′-trifluoromethylbenzidine; TBA: 2,4,6-tribromoaniline

The polyimide polymer can be produced either with or without a property modifying moiety, as seen in Table 1. A reference polymer can be defined as the polyimide polymer with identical monomers, except the reference polymer does not include the property modifying moiety. Therefore, the properties of the polyimide polymer with the property modifying moiety can be compared to the reference polymer to demonstrate the effect of the property modifying moiety. The properties of the reference polymer can be identified with the term “reference.” As can be seen, the CTE for the polyimide polymer produced with the moiety amine can be greater than the reference CTE for the reference polymer, while the CHE of the polyimide polymer produced with the moiety amine is less than the reference CHE of the reference polymer. This process can be used to adjust the CTE and the CHE in opposite directions, which can facilitate adjusting the CTE to within a desired first range, and adjusting the CHE to within a desired second range. Additionally, the adjustment of the CTE and CHE can be done independently, so a user can select a wide variety of CTE ranges to go with a set CHE range, or vice versa. As discussed above, the selection of monomers and the selection of the property modifying moiety are additional tools available to adjust the CTE and CHE.

Many polyimides are not soluble after imidization, but they are soluble as amic acids. A polyimide with the desired CTE may not be soluble, so attaching a bulky, hydrophobic property modifying moiety to the polyimide after imidization may be difficult because reactants tend to mix better when in solution. Also, attaching a bulky, hydrophobic property modifying moiety to a polyimide after imidization can require the polyimide to include a free functional group for attachment. Monomers with available functional groups may not be commercially available, or they may be prohibitively expensive, or they may provide undesirable properties to the resulting polymer. The technique described above allows inclusion of the desired property modifying moiety into a polyimide polymer even if there are no free functional attachment points.

### Synthesis of a Photosensitive Polyimide Formulation

Some polyimide precursor solutions include photosensitive moieties, which allow for pattern formation in the resultant polyimide film. The photosensitive moieties in negative tone photosensitive polyimides form a crosslink upon exposure to appropriate frequencies and intensities of electromagnetic radiation. These photosensitive moieties are sometimes referred to as a photopackage. The photopackage described below, or other photopackages, can be included with the process described for controlling CTE and CHE, as desired.

In practice, the photosensitive polyimide precursor solution is formed into a film, and certain portions of the film are exposed to the appropriate frequency of electromagnetic radiation in a lithography processing step. By using a mask to control the areas where the photosensitive polyimide precursor film is exposed to light, films with specific, controlled patterns, shapes, or designs can be produced. The exposed areas become crosslinked and are rendered insoluble in the developing medium, while the areas which were not irradiated are removed during the film development. The remaining film is then cured to form a pattern shaped by exposure to electromagnetic radiation. Therefore, the shape of the polyimide film is defined by the mask. During the curing polymers formed from photosensitive polyimide precursor solutions comprised of polyamic esters and polyamic acid salts, the polymer rearranges from the polyamic acid to the polyimide and the cross linking agents are evolved as a gas, as understood by one skilled in the art. Additional compounds are included in the photopackage to facilitate the cross linking process.

In one embodiment, a photosensitive polyimide formulation is desired. The process described below gives one example of a beneficial use for the current invention. A reaction mass is prepared by combining approximately equimolar ratios of acid monomers with diamine monomers. The diamine monomer is added in 1% excess by molar ratio to the acid monomers. It should be understood that this is just one example, and other monomers, molar ratios, and different photosensitive compounds and photopackages could be used in alternate examples. The acid monomers and the diamine monomer are mixed together to form a reaction mass with a polyamic acid.

N-diethylaminoethyl methacrylate (DEAEMA) is added to the reaction mass, and the reaction mass is mixed. This forms a polyamic salt, and the DEAEMA serves as a photo cross linking agent in the photopackage. A moiety amine with a connected property modifying moiety is then added to the reaction mass and mixed in. Next, the photoinitiator, such as 2 dimethylamino-2-(4-methylbenzyl)-1-(4-morpholin-4-yl phenyl)butan-1-one, an alpha amino ketone photoinitiator offered under the trademark IRGACURE 379, and photosensitizer, such as N-phenyldiethanolamine (NPD), are added to the reaction mass. Finally, an adhesion promoter such as (3-aminopropyl)triethoxysilane (APS) may be added to the reaction mass. After the APS is mixed in, the reaction mass is filtered, sealed, and chilled. The chilled reaction mass is stored until needed at approximately −20 degrees centigrade (C). The reaction mass is warmed and used to make a final polyimide product at a later date. This can entail forming the reaction mass into a film, exposing the film to the desired frequency of electromagnetic radiation, dissolving soluble polyamic acids or polyamic salts which have not been exposed to the electromagnetic radiation, and imidizing the remaining film.

### Example 2

### Oligomeric Silsesquioxane

Polyimide polymers are subject to rapid degradation in some highly oxidizing environments, such as an oxygen plasma or atomic oxygen [AO], as are most hydrocarbon- and halocarbon-based polymers. AO is present in low earth orbit [LEO], so many spacecraft experience this highly oxidizing environment. The interactions between the oxidizing environment and the polymer material can erode and reduce the thickness of the polymer material. To prevent the erosion, protective coatings including metals, metal oxides, ceramics, glasses, and other inorganic materials are often applied as surface treatments to polyimides subjected to the oxidizing environment.

While these coatings are effective at preventing the oxidative degradation of the underlying material, they often experience cracking from thermal and mechanical stresses, mechanical abrasion, and debris impact. After cracking, the protective surface is compromised and the underlying polymeric material can be degraded from additional exposure to the oxidizing environment. Therefore, the availability of polymers which are able to resist AO degradation is desirable. Also, there is a significant cost associated with launching additional weight into orbit. Eliminating or reducing the weight of protective materials can help lower launch costs.

Oligomeric silsesquioxanes [OS] can be incorporated into a polyimide matrix to improve the durability of polyimides in oxidizing environments. Often, polyimides with incorporated OS demonstrate improved resistance to AO degradation prevalent in LEO environments. Polyimides with incorporated OS provide additional benefits as well. Polyhedral OS are referred to by the trademark POSS™, and are a common form of OS.

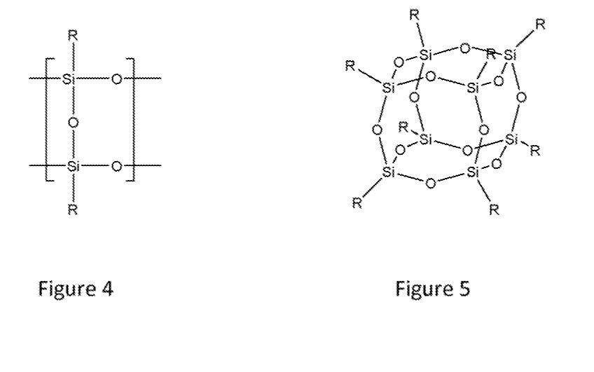

Oligomeric silsesquioxane (OS) compounds or groups are characterized by having the general formula of [RSi]ₙ[O_{1.5}]ₙ wherein the R represents an organic substituent and the Si and the O represent the chemical symbols for the elements silicon and oxygen. R can be aliphatic, aromatic, and can even include compounds which do not include carbon. The silicon atoms are connected together through the oxygen atoms, with the R groups connected to the silicon atoms, as seen in FIG. 4. In this description, these R groups are referred to as pendent from the OS compounds. These OS compounds have hybrid organic and inorganic properties. The Si—O groupings provide the inorganic properties, and the attached R groups provide the organic properties. Frequently, these OS compounds exist in a cage form such that a polyhedron is created by the silicon and oxygen atoms, as shown in FIG. 5. When the OS compound is in the cage form or the polyhedral form, the R groups are exterior to the cage, with the Si atoms generally forming corners of the cage. The OS compound in the cage form is referred to as polyhedral oligomeric silsesquioxane (POSS). POSS is one form of an OS compound.

Frequently, the OS compound will have an organic substituent which has a functional group. These OS compounds can therefore have organic substituents with varying structures connected to the different Si atoms within a single OS compound. A typical example would be a POSS represented by the formula [RSi]₍ₙ₋₁₎ [R′A]₁[O_{1.5}]ₙ, wherein R′ symbolizes an organic substituent with a functional group which can be used to connect the POSS compound to a polymer or some other molecule. The R′ group can be a “tether” when connecting an OS group to a polymer backbone. In this case, the A is used to represent an element. This element is usually Si, but can also be other elements, including aluminum (Al), boron (B), germanium (Ge), tin (Sn), titanium (Ti), and antimony (Sb). These different atoms incorporated into the OS compound provide different properties which will be imparted to the polymer.

Incorporating a POSS group into a polyimide polymer can affect many properties of the polymer, including oxidative stability, temperature stability, glass transition temperature, solubility, dielectric constant, tensile properties, thermomechanical properties such as CTE, optical properties, CHE and other properties. If the POSS has pendent aliphatic groups connected to the Si molecules, the POSS tends to be hydrophobic. The POSS is also a large, bulky constituent. One significant characteristic improved by incorporation of OS in a polyimide polymer is increased resistance to degradation in oxidizing environments, such as oxygen plasma and AO, as discussed above. Oligomeric silsesquioxanes [OS] can be incorporated into a polyimide matrix to improve the durability of polyimides in these environments. Therefore, polyimide polymers with incorporated OS are desirable.

POSS has been blended with polymers to modify the polymer properties, but the amount of POSS which can be blended with a polymer is limited. Blending refers to mixing without the components forming a chemical bond. Typically, the amount of POSS incorporated into the polymer by blending methods is limited to a concentration where the POSS compounds do not aggregate into domains large enough to scatter visible light. This can often be seen as a haze in the polyimide formed. Incorporation of additional POSS above this level typically results in a reduction in optical and/or mechanical properties. This description provides a process for evenly dispersing OS into a polyimide in quantities that would normally cause haze. The OS (or POSS) is a property modifying moiety that can be connected to a moiety amine and added to the polyamic acid prior to imidization, as previously described.

### Detailed Examples

### Run 1—Polyimide Incorporating 20% (w/w) POSS from POSS-Amine

To a 250 milliliter (mL) three-neck round bottom flask equipped with an overhead stirrer, thermometer, and rubber septa were added 12.24 g PMDA. The flask was sealed and purged with dry nitrogen for 1 hour with gentle agitation from the overhead stir shaft. To a separate 250 mL single-neck round bottom flask were added 11.13 g ODA (4,4-oxydianiline) and a magnetic stirbar. The flask was sealed and purged with dry nitrogen for 1 hour. 127 g NMP solvent was introduced into the amine-containing flask and mixed with a dry nitrogen sparge and vigorous agitation. The amine solution was transferred to the dianhydride-containing flask while applying slow stirring from the overhead stir shaft under a dry nitrogen blanket. The solution was allowed to react over the course of 8 hours at room temperature of approximately 23 degrees centigrade to form a viscous polyamic acid solution. 5.33 g aminopropylisobutyl POSS was slurried with 25 g NMP for five minutes, and the resultant slurry was mixed into the polyamic acid solution and allowed to mix for an additional sixteen hours at room temperature of approximately 23 degrees centigrade. The resultant solution is approximately 25,000 cp in viscosity at 25 degrees Celsius. The resulting solution was thinned to approximately 10,000 cp with additional NMP and stored at −20 degrees Celsius. After 48 hrs in storage at −20 degrees Celsius, the solution was allowed to warm to room temperature overnight, and the viscosity was found to be approximately 10,000 cp. The solution was spin cast onto a glass plate, and the wet film was dried by introducing it into a forced-air oven pre-heated to 90° C. and subsequently heated to 300° C. over the course of two hours. The resultant polyimide film was examined and found to be 25 microns in thickness, mechanically tough, withstands fingernail creasing, and without haze. A mechanically tough film which withstands fingernail creasing can be one indication that the polymer chain length is above the minimum useful chain length.

### Run 2—Low CTE Polyimide Incorporating 20% (w/w) POSS from POSS-Amine

The procedure from Run 1 was followed, except that PMDA was replaced with 17.17 g s-BPDA and ODA was replaced with 6.25 g p-PDA. The resultant polyimide film was examined and found to be 25 microns in thickness, mechanically tough, withstands fingernail creasing, without haze, and exhibits a linear CTE of 11 ppm/° C.

### Run 3—Photodefinable Polyimide Precursor and Low CTE Polyimide Incorporating 20% (w/w) POSS from POSS-Amine

The procedure from Run 2 was followed, except that after the polyamic acid solution exhibited a solution viscosity of 25,000 cp, 21.62 grams DEAEMA (diethylamino ethyl methacrylate) and 1.78 grams of an alpha amino ketone photoinitiator offered under the trademark IRGACURE 379 was added and the solution was allowed to mix for four hours, resulting in a viscosity of approximately 27,000 cp. 5.33 g aminopropylisobutyl POSS was slurried with 25 g NMP for five minutes, and the resultant slurry was mixed into the polyamic acid solution and allowed to mix for an additional sixteen hours. The resultant solution is approximately 25,000 cp in viscosity at 25 degrees Celsius. The resulting solution was thinned to approximately 10,000 cp with additional NMP and stored at 23 degrees Celsius. After 48 hrs in storage at 23 degrees Celsius, the solution viscosity was found to be approximately 6,000 cp. The solution was spin cast onto a glass plate, and the wet film was dried by introducing it into a forced-nitrogen oven pre-heated to 90° C. and subsequently heated to 300° C. over the course of two hours. The resultant polyimide film was examined and found to be 25 microns in thickness, mechanically tough, withstands fingernail creasing, and without haze.

### Run 4 Polyimide Incorporating 20% (w/w) POSS from POSS-Amine Salt

The procedure from Run 1 was followed, except that aminopropylisobutyl POSS was first reacted with a solution of hydrochloric acid (HCl) in tetrahydrofuran (THF) solution at room temperature for four hours. The THF was evaporated under vacuum to yield a white powder residue. 5.50 g of this residue was added to the polyamic acid solution, which was mixed for an additional sixteen hours. The viscous solution was thinned with NMP to approximately 10,000 cp, filtered through a 1 micron absolute filter, and stored at 23 degrees C. After 48 hrs in storage at 23 degrees Celsius, the solution viscosity was found to be approximately 6,000 cp. The solution was then spin cast onto a glass plate, and the wet film was dried by introducing it into a forced-air oven pre-heated to 90° C. and subsequently heated to 300° C. over the course of two hours. The resultant polyimide film was examined and found to be 25 microns in thickness, mechanically tough, withstands fingernail creasing, and without haze.

### Run 5—Polyimide Incorporating 20% (w/w) POSS from BOC-Protected POSS-Amine

The procedure from Run 1 was followed, except that 10.0 g aminopropylisobutyl POSS was first reacted with a solution mixture of 3.03 g di-tert-butyl dicarbonate and 2.31 g triethyl amine (TEA) in 50 mL THF solution at room temperature for six hours, and then refluxed for two hours. The THF evaporated at room temperature under vacuum to yield a white powder residue. 6.03 g of this residue was added to the polyamic acid solution, which was mixed for an additional sixteen hours. The viscous solution was thinned with NMP to approximately 10,000 cp, filtered through a 1 micron absolute filter, and stored at 23 degrees. After 48 hrs in storage at 23 degrees Celsius, the solution viscosity was found to be approximately 10,000 cp. The solution was spin cast onto a glass plate, and the wet film was dried by introducing it into a forced-air oven pre-heated to 90° C. and subsequently heated to 300° C. over the course of two hours. The resultant polyimide film was examined and found to be 25 microns in thickness, mechanically tough, withstands fingernail creasing, and without haze.

### Run 6—Polyimide Incorporating 20% (w/w) POSS from POSS-Amine

The procedure from Run 1 was followed, except that the polyamic acid solution at approximately 10,000 cp viscosity was stored at 23 degrees Celsius. After 72 hrs storage, the viscosity was approximately 100 cp. The solution was cast and cured as in Example 1, and the resultant coating was brittle and cracked upon handling.

### Run 7—Polyimide Incorporating 20% (w/w) POSS from Acetyl-Blocked POSS-Amine

The procedure from Run 1 was followed, except that 10.0 g aminopropylisobutyl POSS was first dissolved into 50 mL methylene chloride, and vigorously mixed with 50 mL 6M sodium hydroxide (NaOH) to form a cloudy mixture. Then resultant mixture was cooled to 0° C. using an ice water bath, and 1.12 g acetyl chloride dissolved separately into 10 mL methylene chloride was added dropwise over the course of one hour. The resultant solution was allowed to react for four hours, and then the organic portion was collected, washed with brine, dried, and evaporated to produce a white powder residue. 5.78 g of this residue was added to the viscous polyamic acid solution, which was mixed for an additional sixteen hours. The viscous solution was thinned with NMP to approximately 10,000 cp, filtered through a 1 micron absolute filter, and stored at 23 degrees Celsius. After 48 hrs in storage at 23 degrees Celsius, the solution viscosity was found to be approximately 10,000 cp. The solution was spin cast onto a glass plate, and the wet film was dried by introducing it into a forced-air oven pre-heated to 90° C. and subsequently heated to 300° C. over the course of two hours. The resultant polyimide film was examined and found to be 25 microns in thickness, mechanically brittle, cracks when folded, and nearly opaque with haze.

### Run 8—Polyimide Incorporating 20% (w/w) POSS from POSS-Silanol

The procedure from Run 1 was followed, except that 5.33 grams of POSS-amine was replaced with 5.33 grams of trisilanol-POSS. The polyamic acid solution at approximately 10,000 cp viscosity was stored at 23 degrees Celsius. After 72 hrs storage, the viscosity was approximately 10,000 cp. The solution was cast and cured as in Example 1, and the resultant coating was opaque with haze, brittle, and cracked upon handling.

### Run 9—Photodefinable Polyimide Precursor and Resultant Low CTE and Low CHE Polyimide Film Incorporating 20% POSS-Amine

The procedure from Run 2 was followed, except that s-BPDA was replaced with 11.90 g PMDA, and p-PDA was replaced with 11.47 g DMB. After the polyamic acid solution exhibited a solution viscosity of approximately 25,000 cp, 20.22 g of DEAEMA (diethylamino ethyl methacrylate) was added and the solution was allowed to mix for four hours, resulting in a solution viscosity of approximately 27,000 cp. 4.64 g aminopropylisobutyl POSS and 1.66 g of an alpha amino ketone photoinitiator offered under the trademark IRGACURE 379 were added to this solution, and the resultant solution was allowed to mix for an additional sixteen hours. The viscous solution was thinned with NMP to approximately 10,000 cp, filtered through a 1 micron absolute filter, and stored at 23 degrees Celsius. After 48 hrs in storage at 23 degrees Celsius, the solution viscosity was found to be approximately 6,000 cp. The solution was spin cast onto a glass plate, and the wet film was soft baked at 90° C., and cured to +325° C. in a forced-nitrogen oven over the course of four hours. The resultant polyimide film was examined and found to be 10 microns in thickness, mechanically tough, withstands fingernail creasing, without haze, and exhibits a linear CTE of −2.6 ppm/° C., and a CHE of 5.9 ppm/% RH.

### Run 10—Photodefinable Polyimide Precursor and Resultant High CTE and Low CHE Polyimide Film Incorporating 20% POSS-Amine

To a 250 mL three-neck round bottom flask equipped with an overhead stirrer, thermometer, and rubber septa were added 7.89 g PMDA and 5.36 g 6FDA (4-4′-[hexafluoroisopropylidene]diphthalic anhydride). The flask was sealed and purged with dry nitrogen for 1 hour with gentle agitation from the overhead stir shaft. To a separate 250 mL single-neck round bottom flask were added 10.14 g DMB and a magnetic stirbar. The flask was sealed and purged with dry nitrogen for 1 hour. 127 g NMP solvent was introduced into the amine-containing flask and mixed with a dry nitrogen sparge and vigorous agitation. The amine solution was transferred to the dianhydride-containing flask while applying slow stirring from the overhead stir shaft under a dry nitrogen blanket. The solution was allowed to react over the course of 8 hours to form a viscous polyamic acid solution. 17.87 g of DEAMA was added and the solution was allowed to mix for an additional four hours. 5.41 g aminopropylisobutyl POSS and 1.66 g of an alpha amino ketone photoinitiator offered under the trademark IRGACURE 379 were added to this solution, and the resultant solution was allowed to mix for an additional sixteen hours. The viscous solution was thinned with NMP to approximately 10,000 cp, filtered through a 1 micron absolute filter, and cast into a film. The wet film was soft baked at 90° C., and cured to +325° C. in a forced-nitrogen oven over the course of four hours. The resultant polyimide film was examined and found to be 10 microns in thickness, mechanically tough, withstands fingernail creasing, without haze, and exhibits a linear CTE of 19.6 ppm/° C., and a CHE of 6.5 ppm/% RH.

### Run 11—Photodefinable Polyimide Precursor and Resultant High CTE and Low CHE Polyimide Film Incorporating 40% 2,4,6′-Tribromoaniline

To a 250 mL three-neck round bottom flask equipped with an overhead stirrer, thermometer, and rubber septa were added 5.47 g PMDA and 7.37 g s-BPDA. The flask was sealed and purged with dry nitrogen for 1 hour with gentle agitation from the overhead stir shaft. To a separate 250 mL single-neck round bottom flask were added 10.54 g DMB and a magnetic stirbar. The flask was sealed and purged with dry nitrogen for 1 hour. 127 g NMP solvent was introduced into the amine-containing flask and mixed with a dry nitrogen sparge and vigorous agitation. The amine solution was transferred to the dianhydrides-containing flask while applying slow stirring from the overhead stir shaft under a dry nitrogen blanket. The solution was allowed to react over the course of 8 hours at room temperature of approximately 23 degrees centigrade to form a viscous polyamic acid solution. 18.57 g of DEAEMA was added and the solution was allowed to mix for an additional four hours. 9.35 g 2,4,6-tribromoaniline (TBA) and 1.53 g of an alpha amino ketone photoinitiator offered under the trademark IRGACURE 379 were added to this solution, and the resultant solution was allowed to mix for an additional sixteen hours at room temperature of approximately 23 degrees centigrade. The viscous solution was thinned with NMP to approximately 10,000 cp, filtered through a 1 micron absolute filter, and cast into a film. The wet film was soft baked at 90° C., and cured to +325° C. in a forced-nitrogen oven over the course of four hours. The resultant polyimide film was examined and found to be 10 microns in thickness, mechanically tough, withstands fingernail creasing, without haze, and exhibits a linear CTE of 15.2 ppm/° C., and a CHE of 4.0 ppm/% RH.

The basic results of the Runs described above are listed in Table 2, below. Table 2 is split into parts A and B to facilitate viewing of the several columns. Several aspects of the current invention are apparent from a review of Table 2. For example, comparison of Runs 1 and 6 shows the effect of arresting the reaction by cooling the reaction mass before equilibrium is reached. Run 3 shows arresting the reaction with a tertiary amine instead of cooling of the reaction mass. Run 4 shows arresting the reaction with an amine salt. Run 5 shows arresting the reaction with a BOC-protected amine. Run 7 shows the effect of adding a property modifying moiety (POSS) where the moiety doesn't react throughout the curing process, so the resulting film has poor performance characteristics.

TABLE 2
Part A
Summary of Various Test Reactions

| | dianhydride | diamine | tertiary amine | moiety |
|---|---|---|---|---|
| run | (amt g) | (amt g) | (amt g) | (amt g) |
| 1 | PMDA | ODA | None | APIB POSS |
| | (12.24) | (11.13) | | (5.33) |
| 2 | s-BPDA | p-PDA | None | APIB POSS |
| | (17.17) | (6.25) | | (5.33) |
| 3 | s-BPDA | p-PDA | DEAEMA (21.62) + | APIB POSS |
| | (17.17) | (6.25) | IRGACURE (1.78) | (5.33) |
| 4 | PMDA | ODA | None | APIB POSS/HCl |
| | (12.24) | (11.13) | | (5.50) |
| 5 | PMDA | ODA | None | APIB POSS/DTBDC |
| | (12.24) | (11.13) | | (6.03) |
| 6 | PMDA | ODA | None | APIB POSS |
| | (12.24) | (11.13) | | (5.33) |
| 7 | PMDA | ODA | None | APIB POSS/acetylCl |
| | (12.24) | (11.13) | | (5.78) |
| 8 | PMDA | ODA | None | TS POSS |
| | (12.24) | (11.13) | | (5.33) |
| 9 | PMDA | DMB | DEAEMA (20.22) | APIB POSS |
| | (11.90) | (11.47) | | (4.64) + IRGACURE 379 (1.66) |
| 10 | PMDA (7.89) + | DMB | DEAEMA (17.87) | APIB POSS (5.41) + IRGACURE |
| | 6FDA (5.36) | (10.14) | | 379 (1.66) |
| 11 | PMDA (5.47) + | DMB | DEAEMA (18.57) | TBA (9.35) + IRGACURE 379 |
| | s-BPDA (7.37) | (10.54) | | (1.53) |

Part B
Summary of Various Test Reactions

| | cool temp | | storage time/ | final viscosity | CTE (ppm/C) & |
|---|---|---|---|---|---|
| run | (C.) | film properties | temp (hr/C.) | (CP) | CHE (ppm/% RH) |
| 1 | −20 | strong/clear | 48/−20 | 10,000 | |
| 2 | −20 | strong/clear | 48/−20 | 10,000 | 11/NA |
| 3 | N/A | strong/clear | 48/+23 | 6,000 | |
| 4 | N/A | strong/clear | 48/+23 | 6,000 | |
| 5 | N/A | strong/clear | 48/+23 | 10,000 | |
| 6 | −20 | brittle | 72/+23 | 100 | |
| 7 | −20 | brittle/hazy | 48/+23 | 10,000 | |
| 8 | −20 | brittle/hazy | 72/+23 | 10,000 | |
| 9 | −20 | strong/clear | 48/+23 | 6,000 | −2.6 & 5.9* |
| 10 | N/A | strong/clear | N/A | 10,000 | 19.6/6.5* |
| 11 | N/A | strong/clear | N/A | 10,000 | 15.2/4.0* |

TS—trisilanol;
amt g—amount in grams;
APIB—aminopropyl isobutyl;
AcetylCl—acetyl chloride
*Run 9 & 10, the film was 10 microns thick to test the CTE and CHE. For all other examples, the film was 25 microns thick.

### CONCLUSION

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

1. A method for forming a polyimide polymer comprising:
a) reacting monomers to form a polyimide precursor to produce a first calculated average polymer chain length that is above a minimum useful average chain length;
b) adding a moiety amine to the polyimide precursor to produce a second calculated average polymer chain length that is below the minimum useful average chain length, where the moiety amine is connected to a property modifying moiety;
c) arresting the chemical reaction between the moiety amine and the polyimide precursor prior to equilibrium; and
d) imidizing the polyimide precursor to produce a polyimide polymer with an actual average polymer chain length that is above the minimum useful average chain length.

2. The method of claim 1 where the monomers of part (a) comprise di-acid monomers and diamine monomers.

3. The method of claim 1 where the property modifying moiety is evenly dispersed in the polyimide polymer.

4. The method of claim 1 where part (c) comprises cooling the polyimide precursor to below a control temperature within a control time after the addition of the moiety amine.

5. The method of claim 1 further comprising adding a tertiary amine to the polyimide precursor prior to part (b).

6. The method of claim 5 where the tertiary amine contains a double bond.

7. The method of claim 1 further comprising protecting the moiety amine prior to part (b) with a protecting group, such that the moiety amine is chemically bound to the protecting group when added to the polyimide precursor but the bond between the moiety amine and the protecting group breaks under the conditions of part (d).

8. The method of claim 7 where the protecting group is selected from the group consisting of a protic acidic compound, di-tert-butyl dicarbonate, t-butoxy carbonyl, and any combination thereof.

9. The method of claim 1 where the moiety amine is a primary amine.

10. The method of claim 1 where the property modifying moiety is selected from the group consisting of an oligomeric silsesquioxane, tribromoaniline, trichloroaniline, and any combination thereof.

11. The method of claim 1 further comprising adding a photopackage to the polyimide precursor.

12. The method of claim 1 where:
the diamine monomer comprises at least one of 4,4′-oxydianiline, 3,4′-oxydianiline, 3,3′-oxydianiline, p-phenylenediamine, m-phenylenediamine, o-phenylenediamine, diaminobenzanilide, 3,5-diaminobenzoic acid, 3,3′-diaminodiphenylsulfone, 4,4′-diaminodiphenyl sulfones, 1,3-bis-(4-aminophenoxy)benzene, 1,3-bis-(3-aminophenoxy)benzene, 1,4-bis-(4-aminophenoxy)benzene, 1,4-bis-(3-aminophenoxy)benzene, 2,2-Bis[4-(4-aminophenoxy)phenyl]-hexafluoropropane, 2,2-bis(3-aminophenyl)-1,1,1,3,3,3-hexafluoropropane, 4,4′-isopropylidenedianiline, 1-(4-aminophenoxy)-3-(3-aminophenoxy)benzene, 1-(4-aminophenoxy)-4-(3-aminophenoxy)benzene, bis-[4-(4-aminophenoxy)phenyl]sulfones, 2,2-bis[4-(3-aminophenoxy)phenyl]sulfones, bis(4-[4-aminophenoxy]phenyl)ether, 2,2′-bis-(4-aminophenyl)-hexafluoropropane, (6F-diamine), 2,2′-bis-(4-phenoxyaniline)isopropylidene, meta-phenylenediamine, para-phenylenediamine, 1,2-diaminobenzene, 4,4′-diaminodiphenylmethane, 2,2-bis(4-aminophenyl)propane, 4,4′ diaminodiphenyl propane, 4,4′-diaminodiphenyl sulfide, 4,4′-diaminodiphenylsulfone, 3,4′ diaminodiphenyl ether, 4,4′-diaminodiphenyl ether, 2,6-diaminopyridine, bis(3-aminophenyl)diethyl silane, 4,4′-diaminodiphenyl diethyl silane, benzidine, 3,3′-dichlorobenzidine, 3,3′-dimethoxybenzidine, 4,4′-diaminobenzophenone, N,N-bis(4-aminophenyl)-n-butylamine, N,N-bis(4-aminophenyl)methylamine, 1,5-diaminonaphthalene, 3,3′-dimethyl-4,4′-diaminobiphenyl, 4-aminophenyl-3-aminobenzoate, N,N-bis(4-aminophenyl)aniline, bis(p-beta-amino-t-butylphenyl)ether, p-bis-2-(2-methyl-4-aminopentyl)benzene, p-bis(1,1-dimethyl-5-aminopentyl)benzene, 1,3-bis(4-aminophenoxy)benzene, m-xylenediamine, p-xylenediamine, 4,4′-diaminodiphenyl ether phosphine oxide, 4,4′-diaminodiphenyl N-methyl amine, 4,4′-diaminodiphenyl N-phenyl amine, amino-terminal polydimethylsiloxanes, amino-terminal polypropyleneoxides, amino-terminal polybutyleneoxides, 4,4′-Methylenebis(2-methylcyclohexylamine), adipic acid, 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-methylenebisbenzeneamine; and
the diacid monomer comprises at least one of hydroquinone dianhydride, 3,3′,4,4′-biphenyl tetracarboxylic dianhydride, pyromellitic dianhydride, 3,3′,4,4′-benzophenone tetracarboxylic dianhydride, 4,4′-oxydiphthalic anhydride, 3,3′,4,4′-diphenylsulfone tetracarboxylic dianhydride, 4,4′-(4,4′-isopropylidenediphenoxy)bis(phthalic anhydride), 2,2-bis(3,4-dicarboxyphenyl)propane dianhydride, 4,4′-(hexafluoroisopropylidene)diphthalic anhydride, bis(3,4-dicarboxyphenyl)sulfoxide dianhydride, polysiloxane-containing dianhydride, 2,2′,3,3′-biphenyltetracarboxylic dianhydride, 2,3,2′,3′-benzophenonetetracarboxylic dianhydride, 3,3′,4,4′-benzophenonetetracarboxylic dianhydride, naphthalene-2,3,6,7-tetracarboxylic dianhydride, naphthalene-1,4,5,8-tetracarboxylic dianhydride, 4,4′-oxydiphthalic dianhydride, tetracarboxylic dianhydride, 3,4,9,10-perylene tetracarboxylic dianhydride, bis(3,4-dicarboxyphenyl)sulfide dianhydride, bis(3,4-dicarboxyphenyl)methane dianhydride, 2,2-bis(3,4-dicarboxyphenyl)propane dianhydride, 2,2-bis(3,4-dicarboxyphenyl)hexafluoropropane, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-,8,9,10-tetracarboxylic dianhydride, pyrazine-2,3,5,6-tetracarboxylic dianhydride, benzene-1,2,3,4-tetracarboxylic dianhydride, thiophene-2,3,4,5-tetracarboxylic dianhydride.

13. The method of claim 1 further comprising storing the polyimide precursor after part (c) at a temperature not exceeding 0 degrees centigrade.

14. A method of preparing a polyimide polymer comprising:
a) selecting monomers for a polyimide polymer;
b) reacting the selected monomers in a reaction mass to produce a polyimide precursor;
c) adding a moiety amine with an attached property modifying moiety to the reaction mass;
d) step for arresting the reaction between the moiety amine and the polyimide precursor prior to equilibrium; and
e) imidizing the reaction mass prior to equilibrium to produce a polyimide polymer with a coefficient of thermal expansion within a desired first range and a coefficient of hydroscopic expansion within a desired second range.

15. The method of claim 14 where the coefficient of hydroscopic expansion for the polyimide polymer produced with the moiety amine is less than a reference coefficient of hydroscopic expansion for a reference polymer, where the reference polymer is a polyimide consisting of the monomers selected in part (a), and the coefficient of thermal expansion of the polyimide polymer produced with the moiety amine is greater than a reference coefficient of thermal expansion of the reference polymer.

16. The method of claim 15 where the property modifying moiety is evenly dispersed in the polyimide polymer.

17. The method of claim 14 where part (d) comprises cooling the reaction mass to less than a control temperature within a control time of part (c)

18. The method of claim 14 further comprising adding a tertiary amine to the polyimide precursor prior to part (c).

19. The method of claim 14 where part (d) comprises protecting the moiety amine prior to part (c) with a protecting group, such that the moiety amine is chemically bound to the protecting group when added to the polyimide precursor but the bond between the moiety amine and the protecting group breaks under the conditions of part (e).

20. The method of claim 14 further comprising adding a photopackage to the reaction mass.

21. A polyimide polymer produced from diamine and diacid monomers comprising:
a property modifying moiety connected to a moiety amine, where the property modifying moiety is evenly dispersed in the polyimide polymer;
a first calculated average polymer chain length above a minimum useful average chain length, the first calculated average polymer chain length being determined by a ratio of diamine monomers to diacid monomers used to produce the polyimide polymer;
a second calculated average polymer chain length below the minimum useful average chain length, the second calculated average polymer chain length being determined by a ratio of diamine monomers, moiety amines, and diacid monomers used to produce the polyimide polymer; and
an actual average polymer chain length above the minimum useful average chain length.

22. The polyimide polymer of claim 21 where the property modifying moiety is selected from the group consisting of an oligomeric silsesquioxane, tribromoaniline, trichloroaniline, and any combination thereof.

23. The polyimide polymer of claim 21 where the polyimide polymer is a film having a shape defined by a mask.

24. The polyimide polymer of claim 21 where the polyimide polymer has a coefficient of thermal expansion between 15 and 20 parts per million per degree centigrade and a coefficient of hydroscopic expansion of less than 8 parts per million per percent relative humidity.

25. The polyimide polymer of claim 21 where the diamine monomer comprises at least one of 4,4′-oxydianiline, 3,4′-oxydianiline, 3,3′-oxydianiline, p-phenylenediamine, m-phenylenediamine, o-phenylenediamine, diaminobenzanilide, 3,5-diaminobenzoic acid, 3,3′-diaminodiphenylsulfone, 4,4′-diaminodiphenyl sulfones, 1,3-bis-(4-aminophenoxy)benzene, 1,3-bis-(3-aminophenoxy)benzene, 1,4-bis-(4-aminophenoxy)benzene, 1,4-bis-(3-aminophenoxy)benzene, 2,2-Bis[4-(4-aminophenoxy)phenyl]-hexafluoropropane, 2,2-bis(3-aminophenyl)-1,1,1,3,3,3-hexafluoropropane, 4,4′-isopropylidenedianiline, 1-(4-aminophenoxy)-3-(3-aminophenoxy)benzene, 1-(4-aminophenoxy)-4-(3-aminophenoxy)benzene, bis-[4-(4-aminophenoxy)phenyl]sulfones, 2,2-bis[4-(3-aminophenoxy)phenyl]sulfones, bis(4-[4-aminophenoxy]phenyl)ether, 2,2′-bis-(4-aminophenyl)-hexafluoropropane, (6F-diamine), 2,2′-bis-(4-phenoxyaniline)isopropylidene, meta-phenylenediamine, para-phenylenediamine, 1,2-diaminobenzene, 4,4′-diaminodiphenylmethane, 2,2-bis(4-aminophenyl)propane, 4,4′ diaminodiphenyl propane, 4,4′-diaminodiphenyl sulfide, 4,4′-diaminodiphenylsulfone, 3,4′ diaminodiphenyl ether, 4,4′-diaminodiphenyl ether, 2,6-diaminopyridine, bis(3-aminophenyl)diethyl silane, 4,4′-diaminodiphenyl diethyl silane, benzidine, 3,3′-dichlorobenzidine, 3,3′-dimethoxybenzidine, 4,4′-diaminobenzophenone, N,N-bis(4-aminophenyl)-n-butylamine, N,N-bis(4-aminophenyl)methylamine, 1,5-diaminonaphthalene, 3,3′-dimethyl-4,4′-diaminobiphenyl, 4-aminophenyl-3-aminobenzoate, N,N-bis(4-aminophenyl)aniline, bis(p-beta-amino-t-butylphenyl)ether, p-bis-2-(2-methyl-4-aminopentyl)benzene, p-bis(1,1-dimethyl-5-aminopentyl)benzene, 1,3-bis(4-aminophenoxy)benzene, m-xylenediamine, p-xylenediamine, 4,4′-diaminodiphenyl ether phosphine oxide, 4,4′-diaminodiphenyl N-methyl amine, 4,4′-diaminodiphenyl N-phenyl amine, amino-terminal polydimethylsiloxanes, amino-terminal polypropyleneoxides, amino-terminal polybutyleneoxides, 4,4′-Methylenebis(2-methylcyclohexylamine), adipic acid, 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-methylenebisbenzeneamine; and
the diacid monomer comprises at least one of hydroquinone dianhydride, 3,3′,4,4′-biphenyl tetracarboxylic dianhydride, pyromellitic dianhydride, 3,3′,4,4′-benzophenone tetracarboxylic dianhydride, 4,4′-oxydiphthalic anhydride, 3,3′,4,4′-diphenylsulfone tetracarboxylic dianhydride, 4,4′-(4,4′-isopropylidenediphenoxy)bis(phthalic anhydride), 2,2-bis(3,4-dicarboxyphenyl)propane dianhydride. 4,4′-(hexafluoroisopropylidene)diphthalic anhydride, bis(3,4-dicarboxyphenyl) sulfoxide dianhydride, polysiloxane-containing dianhydride, 2,2′,3,3′-biphenyltetracarboxylic dianhydride, 2,3,2′,3′-benzophenonetetracarboxylic dianhydride, 3,3′,4,4′-benzophenonetetracarboxylic dianhydride, naphthalene-2,3,6,7-tetracarboxylic dianhydride, naphthalene-1,4,5,8-tetracarboxylic dianhydride, 4,4′-oxydiphthalic dianhydride, 3,3′,4,4′-biphenylsulfone tetracarboxylic dianhydride, 3,4,9,10-perylene tetracarboxylic dianhydride, bis(3,4-dicarboxyphenyl)sulfide dianhydride, bis(3,4-dicarboxyphenyl)methane dianhydride, 2,2-bis(3,4-dicarboxyphenyl)propane dianhydride, 2,2-bis(3,4-dicarboxyphenyl)hexafluoropropane, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-,8,9,10-tetracarboxylic dianhydride, pyrazine-2,3,5,6-tetracarboxylic dianhydride, benzene-1,2,3,4-tetracarboxylic dianhydride, thiophene-2,3,4,5-tetracarboxylic dianhydride.

26. The polyimide polymer of claim 21 where the polyimide polymer is formed into a film.
